(19) United States
(12) Patent Application Publication
(10) Pub. No.: US 2005/0113076 A1
(43) Pub. Date: May 26, 2005

(54) Method and apparatus for searching for expected caller by matching caller ID to phone book

(76) Inventor: Tae-Hee Lee, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/992,101

(22) Filed: Nov. 19, 2004

(30) Foreign Application Priority Data
Nov. 20, 2003 (KR) 2003-82602

(51) Int. Cl. H04M 3/42

(52) U.S. Cl. 455/415

(57) ABSTRACT

Provided is a method and apparatus for searching for an expected caller using a caller identifier (ID) in a mobile communication system. Upon receiving a call reception request from a caller, the terminal searches a phone book for a phone number which is fully identical to the caller ID. If there is no phone number that is fully identical to the caller ID, the terminal searches the phone book for a phone number that is identical to the caller ID in part. If there is a phone number that is identical to the caller ID in part, the terminal displays information on the searched phone number as expected caller information.

### PRIORITY

This application claims priority under 35 U.S.C. § 119(a) to an application entitled “Method for Searching for Expected Caller by Matching Caller ID to Phone Book” filed in the Korean Intellectual Property Office on Nov. 20, 2003 and assigned Serial No. 2003-82602, the entire contents of which are incorporated herein by reference.

### BACKGROUND OF THE INVENTION

1. Field of the Invention

The present invention relates generally to a method for searching for a caller using a caller identifier (ID) in a mobile communication terminal such as a mobile phone. In particular, the present invention relates to a method for searching for an expected caller number, depending upon a common feature between a received caller ID, and phone numbers registered in a phone book of a mobile phone.

2. Description of the Related Art

As phones gain in popularity, the phones are used in various environments. In particular, with the progress of mobile communication technology, many people use mobile phones and cordless phones as their home telephone. Now, therefore, people can enjoy a phone call anytime anywhere. However, the rapid gain in popularity of the phone shows an increase in violations of phone etiquette by the many users.

Generally, malicious calls, such as prank calls, indecent calls, seductive calls and threatening calls, place heavy moral pressure on, and cause stress and anxiety to the called parties, thereby causing a serious social problem. Up to now, many attempts have been made to prevent malicious calls. For individual convenience and privacy protection, a caller ID service is currently provided. The caller ID service informs the called party of the phone number of a calling party and leaves information on the calling party in the absence of the called party so that the called party can know from whom the absent call was received. An absent call is defined as a call that was received at the mobile communication terminal, but the user did not execute a call request. This service releases users from the stress caused by the unexpected malicious calls, and allows users to check phone numbers displayed on the terminal and select a desired phone number to accept by executing a call request, thereby preventing the caller undue stress.

The possible number of phone numbers to be stored in a memory of current mobile phone is several hundred or several thousand, and the users cannot remember all of the phone numbers. In addition, each person may have several phone numbers, such as a mobile phone number, an office phone number and a home phone number. In this case, if an unregistered phone number of the calling party is received (or displayed), the user cannot recognize the information on the calling party because that number is not registered in the memory of the mobile phone.

FIG. 1 is a flowchart illustrating the operation of displaying a caller ID in a mobile communication terminal according to the prior art. Referring to FIG. 1, the terminal that is in an idle state (step 10) receives the caller ID of a corresponding incoming call from a network before the incoming call is connected (step 12). Upon receiving the caller ID, the terminal searches its phone book for the caller ID (step 14). Thereafter, the terminal determines whether the received caller ID is fully identical to any one of the phone numbers in the phone book (step 16). If it is determined in step 16 that the received caller ID is identical to none of the phone numbers in the phone book, the terminal displays the caller ID as an unconfirmed phone number (step 20), and then proceeds to step 22. However, if it is determined in step 16 that the received caller ID is identical to one of the phone numbers in the phone book, the terminal displays detailed information about the corresponding phone number (step 18), and then proceeds to step 22. The detailed information includes caller's name, mobile phone number, office phone number, home phone number, etc.

In step 22, the terminal determines whether a call request is input from the user. If a call request is input from the user, the terminal transitions to an active state (step 24), and if no call request is input from the user, the terminal ends the operation. The terminal in the active state determines whether a call end request is input from the user (step 26). If a call end request is input from the user, the terminal ends the active state and, and if no call end request is input from the user, the terminal maintains the active state.

In the conventional caller ID displaying method described above, it is not possible to display information on the caller unless the caller ID is fully identical to any one of the phone numbers registered in the phone book of the mobile phone.

Generally, a key-phone system (or Info-Mobile system) is used within a company or an apartment complex. The key-phone system provides a service for implementing a function of a wired phone with a mobile phone within a particular area such as office building, campus, and apartment complex. In the same area, a user can simply perform a call with an extension number. The existing caller ID displaying algorithm can recognize caller information only when a caller ID is fully identical in all of service provider number, telephone office number, and individual identification number. That is, if a user presses only 4 digits of, for example, #5911, to make a call with an extension number, the terminal cannot search for information on a caller because the 4-digit number is different in format from normal phone numbers stored therein.

Further, in the conventional caller ID displaying method described above, in a caller ID service, if a received caller ID is not identical in format to normal phone numbers, the terminal cannot recognize information on the caller.

### SUMMARY OF THE INVENTION

It is, therefore, an object of the present invention to provide a method for searching for an expected caller using a caller ID in a mobile communication terminal in which even though the caller ID is fully identical to none of the phone numbers stored in a phone book of the terminal, the terminal is allowed to display information regarding an expected caller.

To achieve the above and other objects, there is provided a method for searching for an expected caller using a caller identifier (ID) in a mobile communication system. The method comprises the steps of: upon receiving a call reception request from a caller, searching a phone book for a phone number that is fully identical to the caller ID; if there is no phone number that is fully identical to the caller ID, searching the phone book for a phone number that is identical to the caller ID in part; and if there is a phone number that is identical to the caller ID in part, displaying information on the searched phone number as expected caller information.

To achieve the above and other objects, there is provided an apparatus for searching for an expected caller using a caller identifier (ID) in a mobile communication terminal. The apparatus comprises a radio frequency (RF) unit for communicating an RF signal with a network and receiving the caller ID from the network upon receiving a call reception request from a caller; a voice processor for exchanging voice signals with the RF unit; a memory for storing a phone book having at least one phone number and its detailed information input by a user; a key input unit for receiving key data input by the user, and outputting the key data to a controller; the controller for searching the phone book for a phone number, that is fully identical to the caller ID upon receiving the call reception request, and searching for a phone number that is identical to the caller ID in part, if there is no phone number that is fully identical to the caller ID; and a display for displaying the caller ID and detailed information regarding the searched phone number.

### BRIEF DESCRIPTION OF THE DRAWINGS

The above and other objects, features and advantages of the present invention will become more apparent from the following detailed description when taken in conjunction with the accompanying drawings in which:

FIG. 1 is a flowchart illustrating an operation of displaying a caller ID in a mobile communication terminal according to the prior art;

FIG. 2 is a block diagram illustrating a mobile communication terminal to which an embodiment of the present invention is applied;

FIG. 3A is a diagram illustrating an example of a phone book stored in a memory of a mobile communication terminal according to an embodiment of the present invention;

FIG. 3B is a diagram illustrating detailed caller information stored in the phone book of the mobile communication terminal according to an embodiment of the present invention;

FIG. 4 is a diagram illustrating a format of a general phone number;

FIG. 5 is a flowchart illustrating an operation of displaying a caller ID in a mobile communication terminal according to an embodiment of the present invention;

FIG. 6A is a diagram illustrating an example of phone numbers displayed on the display according to an embodiment of the present invention;

FIG. 6B is a diagram illustrating an example of phone numbers displayed on the display 15 according to an embodiment of the present invention;

FIG. 6C is a diagram illustrating an example of phone numbers displayed on the display 15 according to an embodiment of the present invention;

FIG. 7A is a diagram illustrating an example of a caller ID displayed on the display according to the prior art; and

FIG. 7B is a diagram illustrating an example of a caller ID displayed on the display according to another embodiment of the present invention.

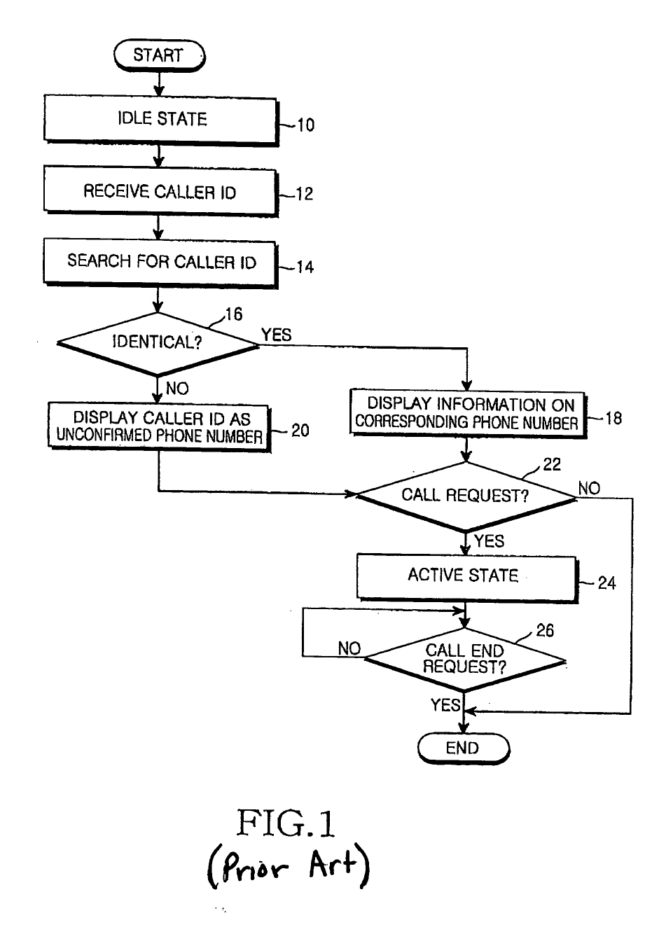

### DETAILED DESCRIPTION OF THE PREFERRED EMBODIMENTS

A preferred embodiment of the present invention will now be described in detail with reference to the annexed drawings. In the following description, a detailed description of known functions and configurations incorporated herein has been omitted for conciseness.

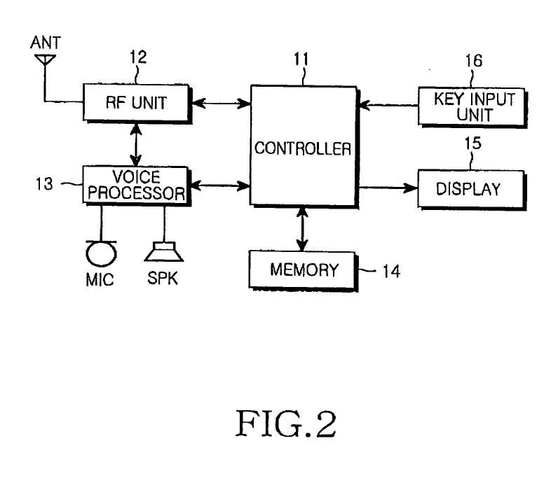

FIG. 2 is a block diagram illustrating a mobile communication terminal to which an embodiment of the present invention is applied. With reference to FIG. 2, a detailed description will now be made of structure and operation of a mobile communication terminal to which an embodiment of the present invention is applied.

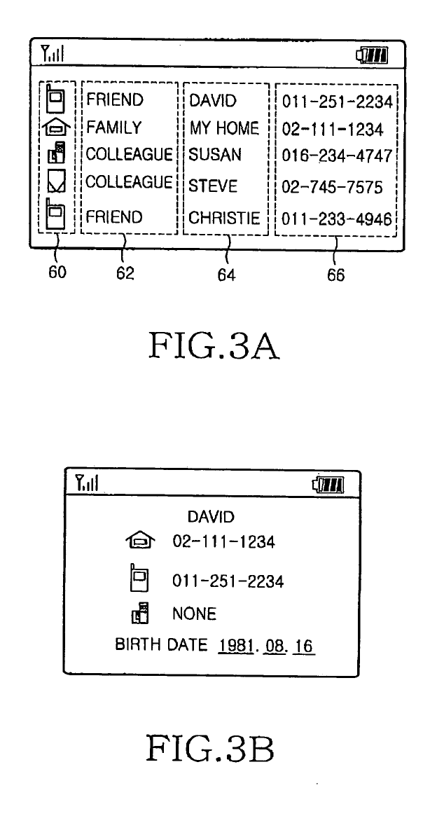

A controller 11 performs the overall control operation of the mobile communication terminal. In particular, the controller 11 performs a control operation of comparing a caller ID with a phone book stored therein according to an embodiment of the present invention. A detailed description thereof will be made below with reference to FIGS. 3A and 3B.

A radio frequency (RF) unit 12, under the control of the controller 11, frequency-down-converts an RF signal received from a network over an RF channel via an antenna ANT. The RF unit 12 distinguishes the types of data received and outputs the received data to the controller 11 or a voice processor 13. The data output from the RF unit 12 to the controller 11 is data received over a traffic channel or a paging signal or a signaling signal received over a control channel. The data output from the RF unit 12 to the voice processor 13 is voice data received when a voice call is set up. Further, the RF unit 12 frequency-up-converts data received from the controller 11 or coded voice data received from the voice processor 13 into a RF signal, and transmits the RF signal to the network via the antenna ANT.

The voice processor 13 is generally comprised of a vocoder and is driven by the controller 11. The voice processor 13 decodes coded voice data received from the RF unit 12, converts the decoded voice data into an electric voice signal, and outputs the electric voice signal to a speaker SPK. The speaker SPK converts the received electric voice signal into an audible sound. Further, the audio processor 13 codes an electric voice signal received from a microphone MIC, and outputs the coded voice signal to the RF unit 12.

A memory 14 can preferably be comprised of a ROM and a RAM, and is divided into an area for storing data necessary for the control operation of the controller 11, an area for storing user data, and an area for temporarily storing data generated during the control operation. That is, the memory 14 is a randomly accessable, readable and writable memory. Further, the memory 14 stores control data in the area for storing data necessary for the control operation, and, in particular, stores a phone book according to an embodiment of the present invention. A display 15 is preferably comprised of a liquid crystal display (LCD) for displaying an operation state in texts and icons such as vibration icon and alarm icon. A key input unit 16, having a general key matrix structure, is preferably comprised of numeric keys for dialing, alphanumeric keys for entering text, and function keys for performing various functions. Further, the key input unit 16 includes an OK key for item selection and a 4-direction key for shifting a cursor. The key input unit 16 generates key data corresponding to a key input by the user, and outputs the key data to the controller 11.

FIG. 3A is a diagram illustrating an example of a phone book stored in the memory 14 of the mobile communication terminal according to an embodiment of the present invention. Referring to FIG. 3A, the phone book stored in the terminal is preferably comprised of a location information field 60 indicating whether a corresponding phone number is a home phone number, a mobile phone number or a office phone number, a group information field 62 indicating whether a corresponding phone number belongs to a friend group, a family group or a colleague group, an ID field 64 for storing names or nicknames, and a phone number field 66 for storing phone numbers. Of course, the names of the groups are not limited to the above list of groups, but can be any name as selected by the user.

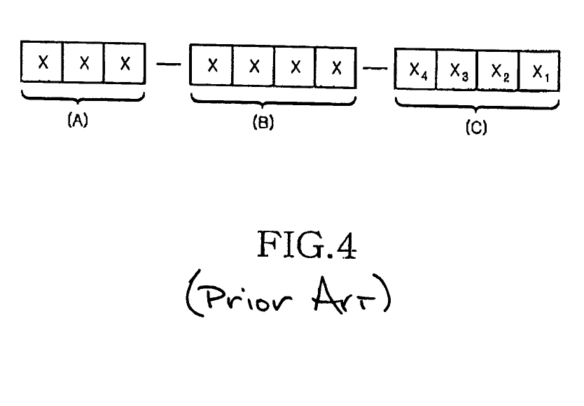

FIG. 3B is a diagram illustrating detailed caller information stored in the phone book according to an embodiment of the present invention. Referring to FIG. 3B, the caller information preferably includes a caller's name, a mobile phone number, a office phone number, a home phone number, a birth date, etc. An LCD of the display 15 displays the current state of the mobile communication terminal, and also displays data input by a user through the key input unit 16 in texts and icons. In addition, the display 15 displays information regarding an absent call according to an embodiment of the present invention, and a detailed description thereof will be made below with reference to FIGS. 3 and 4.

FIG. 4 is a diagram illustrating a format of a general phone number displayed as a caller ID. Referring to FIG. 4, a general phone number is comprised of a 2 or 3-digit service provider number or district number (A), a 3 or 4-digit telephone office number (B), and a 4-digit individual identification number (C), and is displayed on the display 15.

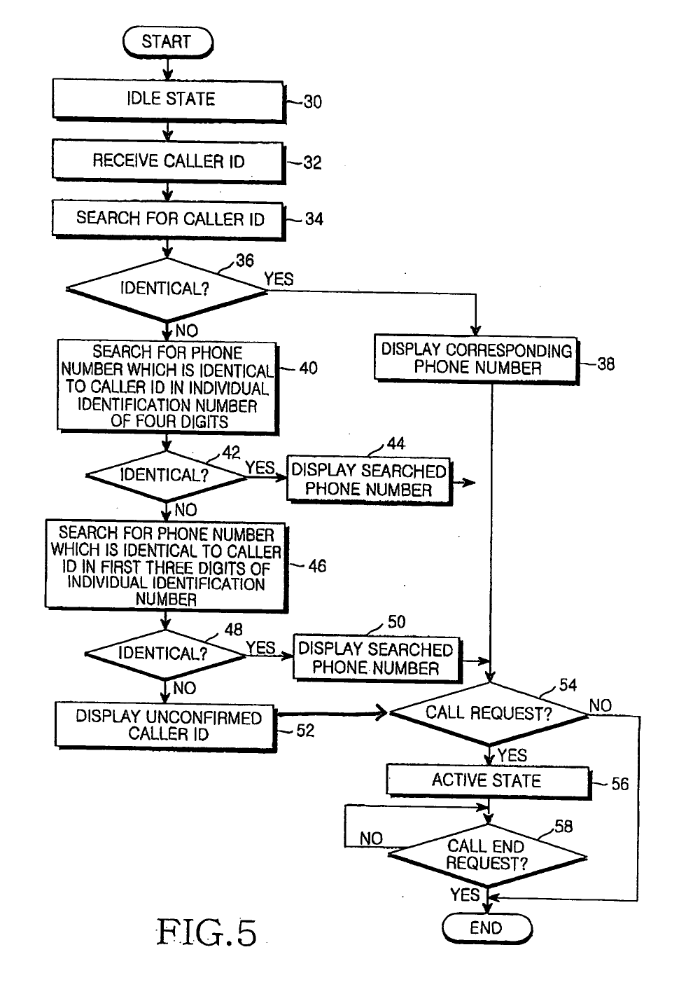

FIG. 5 is a flowchart illustrating an operation of displaying a caller ID in a mobile communication terminal according to an embodiment of the present invention. Referring to FIG. 5, the terminal staying in an idle state (step 30) previously receives a caller ID of a corresponding incoming call from a network before the incoming call is connected (step 32). Upon receiving the caller ID, a controller 11 of the terminal searches its phone book for the caller ID (step 34). Thereafter, the controller 11 determines whether the received caller ID is identical to any one of the phone numbers in the phone book (step 36). If it is determined in step 36 that the received caller ID is identical to one of the phone numbers in the phone book, the controller 11 displays detailed information about the corresponding phone number stored in a memory 14 on a display 15 of the terminal (step 38). The detailed information preferably comprises a caller's name, a mobile phone number, an office phone number, a home phone number, etc.

For example, if the received caller ID is ‘011-251-2324’ which is identical to a mobile phone number of David registered in the phone book of the terminal, the controller 11 displays the name and the mobile phone number of David on the display 15.

However, if it is determined in step 36 that the received caller ID is identical to none of the phone numbers in the phone book, the controller 11 searches the phone book for a phone number that is identical to the received caller ID in an individual identification number (C) of four digits (step 40).

If the controller 11 succeeds in searching for a phone number whose individual identification number is identical to an individual identification number of the received caller ID (step 42), the controller 11 displays the searched phone number on the display 15 as an expected caller ID together with the received caller ID (step 44).

If it is determined in step 42 that the controller 11 fails in searching for a phone number whose individual identification number is identical to an individual identification number of the received caller ID, the controller 11 searches again the phone book for a phone number whose first three digits X₄X₃X₂ for the individual identification number, except the last digit X₁, are identical to those for the individual identification number of the received caller ID (step 46).

The reason for checking the first three digits of the individual identification number is because if a particular individual identification number has already been assigned to another terminal, a new individual identification number with only the last digit changed is generally assigned to the corresponding terminal. Further, in many cases, a user determines his or her home phone number or extension number used in the office such that first three digits of the corresponding individual numbers are identical to each other, which makes them easier to remember. However, the present invention is not necessarily restricted to the method of checking the first three digits of the individual identification number. Alternatively, the present invention can also be applied to a method of searching for a phone number, which is identical to the received caller ID in the other parts.

The controller 11 determines whether the first three digits of the individual identification number are identical to those of the individual identification number of the received caller ID (step 48). If it is determined in step 48 that the first three digits of the searched individual identification number are not identical to those of the individual identification number of the received caller ID, the controller 11 displays the corresponding caller ID on the display 15 as an unconfirmed caller ID (step 52). However, if it is determined in step 48 that the first three digits of the searched individual identification number are identical to those of the individual identification number of the received caller ID, the controller 11 displays the searched phone number and its associated detailed information on the display 15 as an expected caller ID together with the received caller ID (step 50).

In the state where the display 15 displays an unconfirmed caller ID (step 52), expected caller information (steps 50 and 44) or received caller information (step 38), the controller 11 determines whether a call request is input from the user (step 54).

If it is determined in step 54 that a call request is input from the user, the controller 11 transitions to an active state (step 56), and if no call request is input from the user, the controller 11 ends the operation. The controller 11 in the active state determines whether a call end request is input from the user (step 58). If it is determined in step 58 that a call end request is input from the user, the controller 11 ends the active state and, and if no call end request is input from the user, the controller 11 maintains the active state.

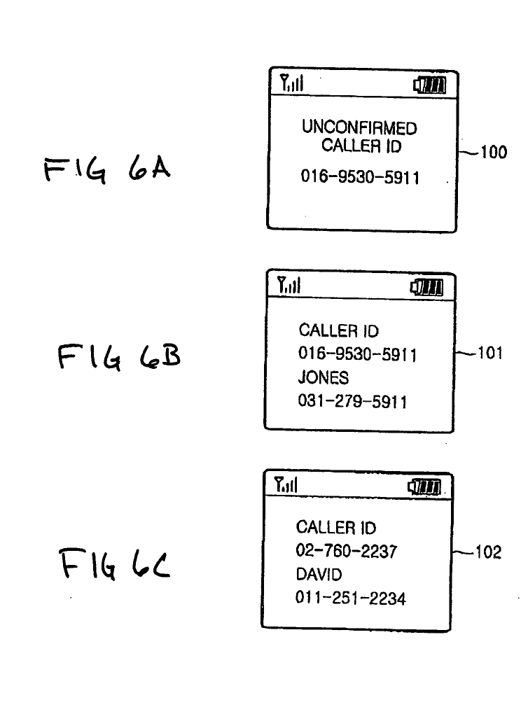

FIGS. 6A through 6C are diagrams illustrating an example of phone numbers displayed on the display 15 according to an embodiment of the present invention. Referring to FIG. 6A, reference numeral 100 represents a screen on which an unconfirmed caller ID is displayed. If a received caller ID is identical to none of the caller IDs stored in the phone book even in the first three digits of the individual identification number, the display 15 displays only the received caller ID as an unconfirmed caller ID (step 52 of FIG. 5).

In FIG. 6B, reference numeral 101 represents a screen on which a searched phone number whose individual identification number is identical to that of the received caller ID is displayed as an expected caller ID together with the received caller ID (step 44 of FIG. 5).

In FIG. 6C, reference numeral 102 represents a screen on which a searched phone number which is identical to the received caller ID only in first three digits of the individual classification number is displayed as an expected caller ID together with the received caller ID (step 50 of FIG. 5).

So far, embodiments of the present invention have been described with reference to the case where a caller ID has a normal format comprised of a service provider number (A), a telephone office number (B), and an individual identification number (C). However, in the case where a caller originates a call using an extension phone in a company or apartment building, a called terminal located in the same company or apartment building will be provided with only a 3 or 4-digit individual identification number. The caller ID search method proposed in the embodiments of the present invention can search for the caller with only the individual identification number.

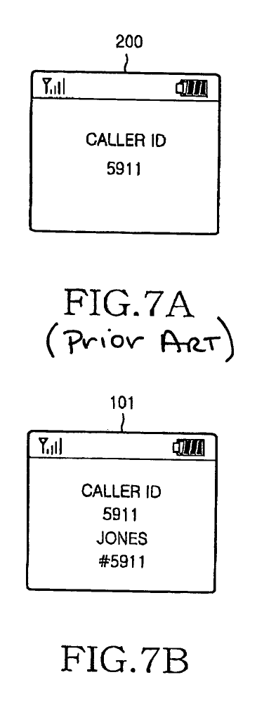

FIG. 7A is a diagram illustrating an example of a caller ID displayed on the display 15 according to the prior art. Referring to FIG. 7A, when a caller with an extension number of ‘#5911’ originates a call, a conventional caller ID search algorithm cannot search for a phone number that is fully identical to a phone number of the caller in a service provider number, a telephone office number and a individual identification number. As illustrated, therefore, the called terminal displays the phone number of the caller as an unconfirmed phone number.

FIG. 7B is a diagram illustrating an example of a caller ID displayed on the display 15 according to another embodiment of the present invention. Referring to FIG. 7B, the caller ID search method proposed in the embodiments of the present invention can search for a phone number in a phone book that is identical to a received caller ID in at least three digits of an individual identification number. As illustrated, therefore, the called terminal displays the searched phone number as an expected caller ID (step 44 or 50 of FIG. 5).

While the invention has been shown and described with reference to a certain preferred embodiment thereof, it will be understood by those skilled in the art that various changes in form and details may be made therein without departing from the spirit and scope of the invention as defined by the appended claims.

1. A method for searching for an expected caller using a caller identifier (ID) in a mobile communication system, comprising the steps of:
receiving a call reception request from a caller, searching a phone book for a phone number that is fully identical to the caller ID;
if there is no phone number that is fully identical to the caller ID, searching the phone book for a phone number that is identical to the caller ID in part; and
if there is a phone number that is identical to the caller ID in part, displaying information on the searched phone number as expected caller information.

2. The method of claim 1, wherein the step of searching for a phone number that is identical to the caller ID in part comprises the step of searching for a phone number that is identical to the caller ID in an individual identification number of last four digits.

3. The method of claim 1, wherein the step of searching for a phone number that is identical to the caller ID in part comprises the step of searching for a phone number that is identical to the caller ID in first three digits of a 4-digit individual identification number.

4. The method of claim 1, wherein the displaying step comprises the step of displaying the caller ID and detailed information on the searched phone number.

5. The method of claim 4, wherein the detailed information includes a location information field indicating whether a corresponding phone number is a home phone number, a mobile phone number or an office phone number; an ID field for storing a name or nickname of the corresponding phone number, and a group information field indicating whether the corresponding phone number belongs to a group category.

6. The method of claim 5, wherein the group category is selected from a list consisting of a friend group, a family group or a colleague group.

7. An apparatus for searching for an expected caller using a caller identifier (ID) in a mobile communication terminal, comprising:
a radio frequency (RF) unit for communicating an RF signal with a network and receiving the caller ID from the network upon receiving a call reception request from a caller;
a voice processor for exchanging voice signals with the RF unit;
a memory for storing a phone book having at least one phone number and its detailed information input by a user;
a key input unit for receiving key data input by the user, and outputting the key data;
a controller for searching the phone book for a phone number that is fully identical to the caller ID upon receiving the call reception request, and searching for a phone number that is identical to the caller ID in part if there is no phone number that is fully identical to the caller ID; and
a display for displaying the caller ID and detailed information regarding the searched phone number.

8. The apparatus of claim 7, wherein the controller searches for a phone number that is identical to the caller ID in an individual identification number of last four digits.

9. The apparatus of claim 7, wherein the controller searches for a phone number that is identical to the caller ID in first three digits of an individual identification number.

10. The apparatus of claim 7, wherein the detailed information includes a location information field indicating whether a corresponding phone number is home phone number, mobile phone number or office phone number; an ID field for storing a name or nickname of the corresponding phone number, and a group information field indicating whether the corresponding phone number belongs to a group category.

11. The apparatus of claim 10, wherein the group category is selected from the list consisting of a friend group, a family group or a colleague group.

12. The apparatus of claim 7, wherein the controller receives key data input by the user from the key input unit.
